(19) United States
(12) Patent Application Publication
(10) Pub. No.: US 2015/0065082 A1
(43) Pub. Date: Mar. 5, 2015

(54) PERSONAL SAFETY DEVICE, SYSTEM AND A METHOD

(71) Applicant: Akhil SEHGAL, Ashburn, VA (US)

(72) Inventor: Akhil SEHGAL, Ashburn, VA (US)

(21) Appl. No.: 14/469,853

(22) Filed: Aug. 27, 2014

(30) Foreign Application Priority Data
Aug. 27, 2013 (IN) 871/CHE/2013

(51) Int. Cl. H04W 4/22; G06F 3/01; H04L 29/08; H04N 5/232

(52) U.S. Cl. CPC H04W 4/22; H04N 5/23203; G06F 3/016; H04L 67/16
USPC 455/404.2

(57) ABSTRACT

The present invention relates to a wearable accessory including a detachable/removable circuitry housing, a vibration generation means for producing a vibration, the vibration generation means housed within the housing, at least one switch for allowing a user of the wearable accessory to cause activation of the vibration generation means, the switch housed within the housing, a module for communicating with at least one handheld device using a communication protocol, an image capturing device including a microphone for receiving audio and video signals at the wearable accessory, a USB port for charging the wearable accessory, a multiple-bit microprocessor is configured and coupled for controlling functions of the wearable accessory, the microprocessor housed within the housing and a storage means for storing data representative of the signals, the storage means coupled with the microprocessor.

### FIELD OF THE INVENTION

The present invention relates to the personal safety devices and, more specifically, to a device or in combination of devices for providing an alarm or distress signal upon activation by the user in order to, for example, deter an attack or to summon assistance.

### BACKGROUND OF THE INVENTION

Historically the primary responsibility for personal protection has always fallen on the individuals. This is true regardless of the community where one lives. Police agencies have been unable to protect everyone. Today, many innocent people find themselves victims of crime. The nature of the crime varies from minor misdemeanors, such as theft, to violent assault, such as rape or murder. Typically, the victim of a crime is physically unable to prevent or deter an attack.

Application of the personal attack alarm is aimed at persons at risk of being attacked outside their home for instance when individuals for one reason or another are out on the streets at night or live in insecure neighborhoods are suddenly attacked. These people may be the elderly, teenagers or women at risk of being attacked. Living in and around our large metropolitan cities requires that individuals, whether alone or with others, take precautionary measures to protect themselves against personal assaults. Various personal safety devices are available, including firearms, stun guns, chemical sprays, audible alarms and wireless security services.

Personal protection devices such as chemical sprays, for example, pepper sprays, audible personal security alarms, and stun guns, when used properly, all have a deterrent effect on an aggressor without the consequences associated with a firearm. These devices, however, have limitations and can prove to be ineffective depending upon the circumstances. Chemical sprays and audible alarms have their advantages and disadvantages. Chemical sprays generally offer a user the advantage of deterring an assailant at a distance of as much as 10 to 15 feet, as well as giving notice to the assailant that the user is not totally defenseless. However, a chemical spray is of no use when the assailant covers his eyes with eyeglasses. Audible alarms on the other hand when used as a standalone device have lost their usefulness, since most people in the metropolitan city areas no longer pay attention to such sound generated devices. Moreover, as such, many people have resorted to carrying lethal weapons, such as hand guns. However, in certain jurisdictions, a person is forbidden by law to possess or use a lethal weapon.

Mobile and wireless technology have touched our lives in a multitude of ways ranging from communicating with near and dear ones to managing different aspects of our personal and business functions. Mobile technology is now also making a foray into personal safety management given the broad range of features and functions it possesses to facilitate things like capturing evidence at the scene of a crime in terms of both sound or visual evidence. It can also help with transmitting various signals for assistance.

The drawback with handheld devices is that users need to visually look at the phone in order to use it. It is very hard to try to use the mobile device in a concealed or hidden way. If the mobile device is in a person's pocket, bag or purse, it makes it that much more difficult to try to access it, look at the device and use it for a particular purpose. And one cannot figure out the current state of the device or operate any of the functions without actually looking at it.

In circumstances where an individual (victim) is being attacked, chances are unlikely that the victim will be able to access their mobile device and reach out for help as the attacker (perpetrator) may seize any known and identifiable deterrents such as the mobile device and escalate the attack leaving the victim with not many options to reach out for help. Having a single mechanism that can be adapted and added to different wearable ornaments to activate the mobile device in a concealed way will make all the difference in the victim's ability at making contact with people that may be able to provide help and assistance. There are some applications currently available that may send out a text message to certain contacts when activated but even to access that functionality, the victim will need to access the mobile device and look at it to activate the application. In essence, this solution also does not really help solve the problem.

Therefore, there is a need for systems and methods that overcome the deficiencies mentioned above that provide a simple, inconspicuous, flexible and easy-to-use means to seek help in the event of a threatening situation and address the above-mentioned drawbacks of traditional systems/approaches.

### SUMMARY OF THE INVENTION

The inventive system and method enhances the process of notifying an emergency situation by allowing a user to send audio (voice based), video, images (pictures) and text based data in addition to the voice based communication by triggering a distress signal using a wearable accessory. Accordingly, one aspect of the present invention relates to a method which enables a user to customize and notify multiple pre-configured members in the user's defined network. In one embodiment, the method follows the steps of (a) triggering an emergency assistance signal by the user via at least one wearable accessory that includes a circuit enclosed by a casing. The circuitry (enclosed in the casing) is removable and can be attached to any other wearable accessory, (b) activating at least one handheld device, upon receipt of the triggered emergency assistance signal from the wearable accessory and establishing a communication thereof using a communication protocol, (c) recording all the events including audio and video at the wearable accessory, transmitting this to a handheld device which in turn transmits the same in real-time to a remote server, (d) receiving an acknowledgement signal from the handheld device to the wearable accessory using the communication protocol, wherein the acknowledgement signal includes a vibration to the wearable accessory which provides confirmation to the user that the emergency assistance signal has been triggered successfully and the same has been sent to a list of pre-configured members stored in the handheld device, and (e) sending alert messages with Global Positioning System (GPS)/Indoor Positioning System (IPS) location to the list of pre-configured emergency contacts of the user via social media, email, text messages, voice message, voice call etc.

Another aspect of the present invention provides a wearable accessory, including housing, a vibration generation means for producing a vibration. The vibration generation means housed within the housing has at least one switch for allowing a user of the wearable accessory to cause activation of the vibration generation means. The switch is housed within the housing and there is a module for communicating with at least one handheld device using a communication protocol, an image capturing device including a microphone for receiving audio and video signals at the wearable accessory, a USB port for charging the wearable accessory, a multiple-bit microprocessor configured and coupled for controlling functions of the wearable accessory. The microprocessor is housed within the housing and there is a storage mechanism for storing data representative of the signals, the storage mechanism is coupled with the microprocessor.

These and various other advantages and features of novelty which characterize the invention are pointed out with particularity in the claims annexed hereto and form a part hereof. However, for a better understanding of the invention, its advantages, and the objects obtained by its use, reference should be made to the drawings which form a further part hereof, and to the accompanying descriptive matter, which illustrates and describes specific examples of an apparatus in accordance with the invention.

### BRIEF DESCRIPTION OF THE DRAWINGS

FIG. 1 shows a schematic diagram of the personal safety communication network which enables a user to customize and notify multiple pre-configured members in the user's defined network.

FIG. 2 shows a flow chart of a method which enables a user to notify multiple pre-configured members in the user's defined network and receive responses back from the pre-defined network, according to one embodiment of the present invention.

FIG. 3 shows the partially exploded view of the wearable accessory's included components used in accordance with the present invention.

### DETAIL DESCRIPTION OF THE INVENTION

In the following description, for purpose of explanation, specific details are set forth in order to provide an understanding of the invention. It will be apparent, however, to one skilled in the art that the invention may be practiced without these details.

One skilled in the art will recognize that embodiments of the present invention, some of which are described below, may be incorporated into a number of enterprise resource planning systems. Structures and devices shown in the figures are illustrative of exemplary embodiments of the invention and are meant to avoid obscuring the invention. Furthermore, connections between components and/or modules within the figures are not intended to be limited to direct connections. Rather, data between these components and modules may be modified, re-formatted or otherwise changed by intermediary components and modules.

References in the specification to “one embodiment” or “an embodiment” means that a particular feature, structure, characteristic, or function described in connection with the embodiment is included in at least one embodiment of the invention. The appearances of the phrase “in one embodiment” in various places in the specification are not necessarily all referring to the same embodiment.

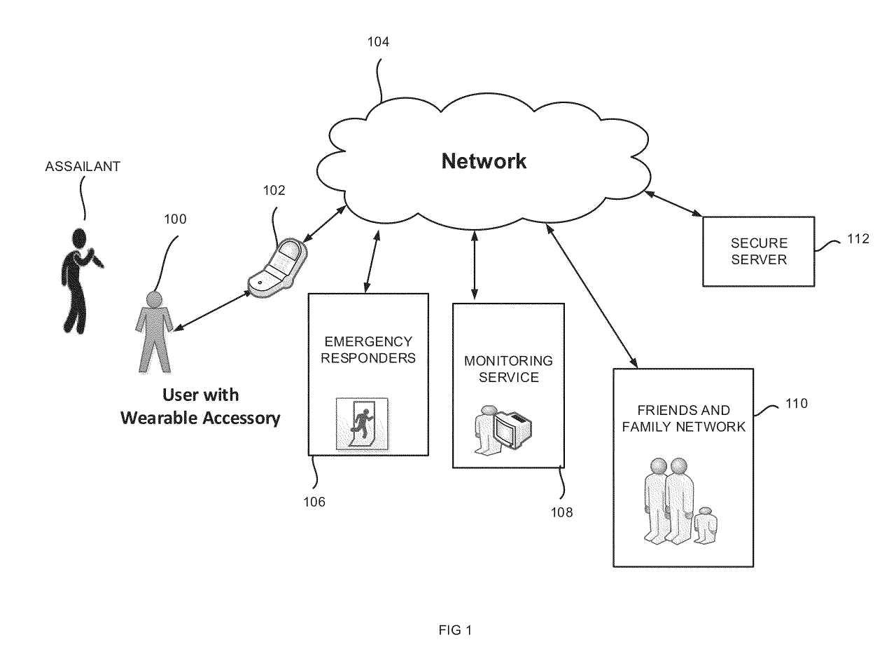

FIG. 1 is a schematic of a personal safety communications network where a user notifies an emergency assistance signal to a plurality of entities i.e. responders which are in the user's defined network. The network includes a handheld device e.g. handheld device 102 which is located on or near the user 100; the user 100 has a wearable accessory. The wearable accessory includes a circuitry enclosed in a casing. Although embedded, the circuitry (enclosed in a casing) has the flexibility of being removed and can be attached to any other wearable accessory. The wearable accessory may be or may include, but is not limited to, a wearable ornament, bracelet, watch, chain, shoe, ear rings, necklace, spectacles, ring etc. having the electronic circuit embedded. The handheld device 102 houses the mobile application that enables the user to customize and pre-configure a list of emergency contacts which can be ordered on a preferential basis. The application provides the user with a means to add, edit, register, save and store personal information (name, sex, DOB, blood type etc.) and also configure the information of the user's emergency contacts. Once Bluetooth connectivity is established with the wearable accessory using secure credentials, it opens the application automatically without any user intervention to perform the set of activities to send out alert messages to the pre-configured list. The handheld device application provides a mechanism to continually sync up with the server and store information/updates on a real-time basis.

The handheld device 102 contains standard or non-standard communication system/protocol which allows the usage of global positioning and data transmission. The application provides near real-time updates on the user's whereabouts to a list of emergency contacts by updating the GPS/IPS information at a pre-determined interval (in secs). The GPS/IPS location is converted into an actual address from the latitude and longitude of the coordinates and can be accessible via google maps.

The network 104 provides the back-bone for the communication path and data transmission capabilities. The handheld device 102 is connected to the network 104. The network typically can consist of be a satellite communication system, one or more cellular phone tower, a wireless communication node, or any combination thereof. The personal safety communications network depicted in FIG. 1 allows for multi-directional (i.e., two-way, and three-way) communications. That is, a third-party response provider can receive and transmit data from/to the handheld device 102, and to the user 100 with wearable accessory via the network 104.

As discussed above, the emergency or distress signal can be a data signal which includes position data. The emergency signal can also include audio data, so that once the signal is activated on the handheld device 102 with the help of the wearable accessory 100, a microphone on the wearable accessory 100 can capture and transmit any audible sounds from the user's environment to the handheld device 102 and then to the third-party response provider in real-time. In yet another embodiment, a camera on the wearable accessory 100 can automatically be activated once the emergency signal is activated. The audio and video data along with other user information and location can be stored on in memory on the handheld device 102 and on a secure server 112.

The various pre-configured contacts in the user's list may include third-party response providers, such as Emergency responders 106, monitoring service 108, and a user's personal friends/family network 110. All these response providers are all part of the network 104. The circuitry in the wearable accessory, the handheld device application, the network and the secure server are in constant communication using the underlying communication protocol to provide real-time updates on the user's location to the list of emergency contacts.

The list of emergency responders 106 includes but is not limited to, police departments, campus security, 911 emergency centers, volunteer organizations, emergency medical service (EMS) providers, rescue departments, volunteers, employees, national security organizations including federal agencies, task forces and non-governmental agencies.

The monitoring service 108 can offer a subscription-based service that monitors the handheld device 102 when triggered by the user's wearable accessory 100. The user's personal friends/family network 110 can include a prioritized pre-determined list of contacts to whom a distress signal is automatically transmitted. The contacts can receive communication in the form of text messages, multi-media messages (MMS), email, a phone call, face time alert with a recorded emergency message. In addition, the emergency contacts can receive distress signals in the form of live audio/videos from the user's handheld device, a social network notification to any of the social networking sites Facebook, LinkedIn etc., an instant messenger notification, or any combination thereof.

In FIG. 1 of the personal safety communications network diagram, the wearable accessory is worn by the user 100, such as on the hand (i.e. bracelet, jewelry), on the finger (i.e. ring), on the head (i.e. hair clip or ornament), around the user's neck (i.e., necklace), on the ankle (i.e., anklet or ankle bracelet), or as a wristband (i.e., watch strap, watch). In this embodiment the wearable accessory serves as a multi-function device that includes signal reception and transmission capabilities. The wearable accessory triggers communication with the handheld device 102 using a communication protocol. The communication protocol may include but is not limited to Bluetooth, Bluetooth low energy, RFID etc. The distress signal can also be directly triggered from the mobile application which enables the user 100 to communicate with a remote location.

The handheld device may be an off-the-shelf smart phone or device, such as an iPhone, iPod, iPad, Blackberry, Android, or other similar system which can be loaded with applications or software. Users will have the capability of downloading an application from the internet, Android Marketplace, and/or the Apple Apps Store. The application may include features that facilitate communication between the user with wearable accessory 100 and the handheld device 102 by means of triggering the distress signal from the user's wearable accessory as described below. In an embodiment, the user can download and use the applications on the handheld device 102 for free while paying for the user's wearable accessory 100. Alternatively, the user may or may not pay for both the application and the wearable accessory.

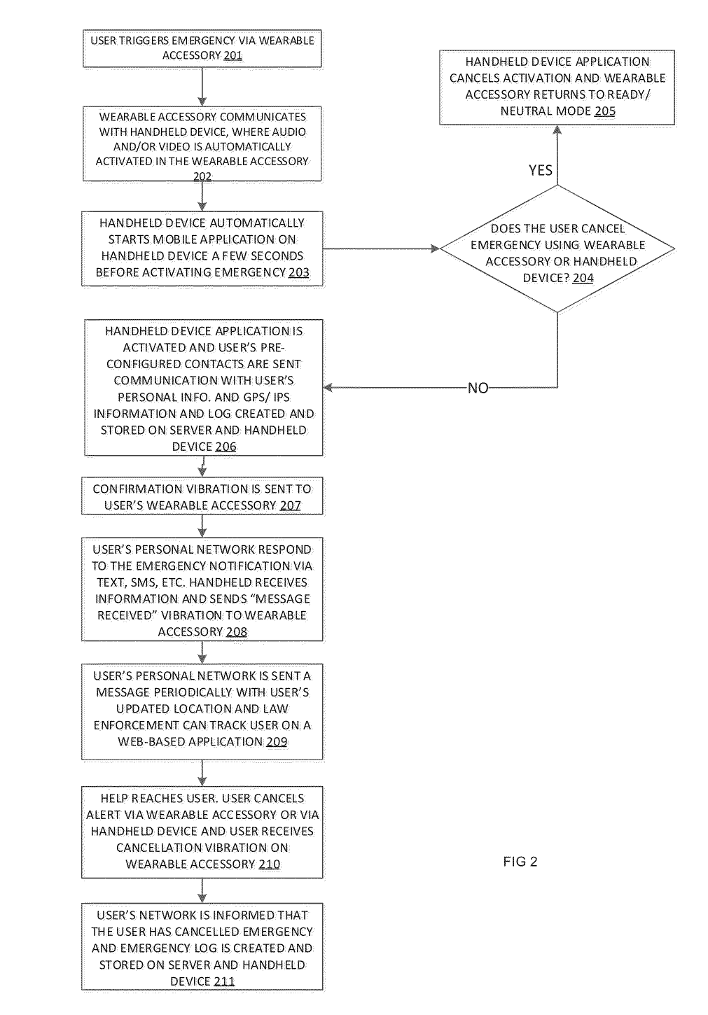

In another embodiment the present invention provides a method 200 for operating the system. The method 200 is explained with reference to FIG. 2. At step 201, an emergency assistance signal is triggered from the wearable accessory having an electronic circuit embedded therein. At step 202, the triggered signal is transmitted to a handheld device thereby activating the device to establish a communication between the device and the wearable accessory using any communication protocol, the communication protocol may include but is not limited to Bluetooth, Bluetooth Low Energy or RFID etc. At step 203, the handheld device automatically starts the application which is a pre-installed application once it receives a command from the circuit through the communication protocol. At step 204, the circuit continuously checks, whether the user has cancelled the emergency assistance signal in order to clarify whether the emergency signal has been wrongly initiated or not. If yes, at step 205, the circuit waits for a predetermined time interval and cancels the activation of the emergency assistance signal, and the wearable accessory and the handheld device return backs to its normal mode. The wearable accessory records all the events including audio or a video or both with the help of the electronic circuit therein and receives a vibration confirming cancellation. At step 206, the triggered signal received at the handheld device generates a distress signal by way of sending alert messages and GPS/IPS location to pre-configured emergency contacts of the user by social media, email, text messages and pre-configured voice messages. In an embodiment of the present invention, the location of the user is determined by Indoor Positioning System (IPS) which is based on magnetic sensor data from the handheld device which is used to wirelessly locate the user inside a building. By using the IPS, one can find the exact location of the user within the building, where the GPS fails to establish the exact indoor locations. Further, the circuitry of the wearable accessory communicates to a remote server with the help of the handheld device or communication device. Upon receiving at the server, in response, at step 207, an acknowledgement signal is received at the wearable accessory via the handheld device. The acknowledgement signal includes a vibration to the wearable accessory in order to provide a confirmation to the user that the emergency assistance signal has been triggered successfully and the same has been sent to the list of pre-configured emergency contacts on the handheld device. The distress signal is transmitted by the handheld device to other location using a network for e.g. a victim's network. It is also possible that the distress signal can be sent simultaneously to all other available networks which are in sync with the electronic circuit of the wearable accessory. In Step 208 of the present invention, at least one person from the user's personal network responds to the emergency notification they received via Step 206. The response might be in the form of text, SMS, MMS, Social Media alert such as facebook, etc. An acknowledgement signal is then received at the wearable accessory via the handheld device. The acknowledgement signal includes a vibration to the wearable accessory in order to provide a confirmation to the user that help is on the way. In another aspect of the present invention, the user's personal network is sent a message periodically with user's updated location where law enforcement can track user on a web-based application, as step 209.

Once help reaches user, the user can cancel the alert via wearable accessory or via the handheld device, as step 210. Upon doing that, the user receives cancellation vibration on wearable accessory and also user's network is informed that the user has cancelled emergency, as in step 211. Further, the emergency log with full event information is created and stored on server and handheld device, as in step 211.

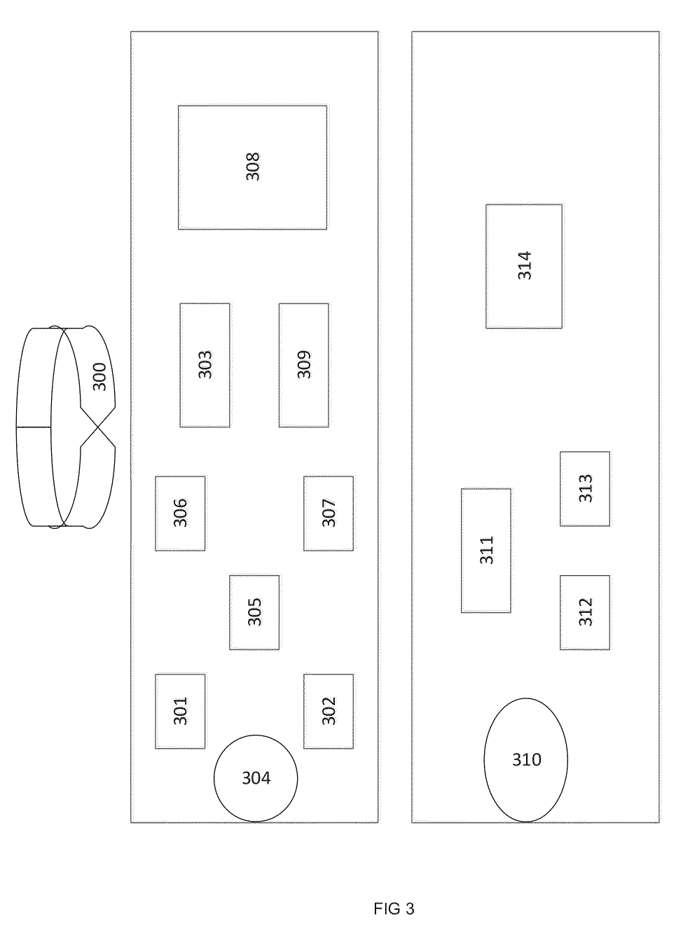

FIG. 3 shows the partially exploded view of the wearable accessory included components used in accordance with the present invention. As shown in the block diagram, the wearable accessory having a housing 300 and includes an electronic circuit embedded thereof which will be worn by a user. The electronic circuit although embedded has the flexibility of being removable and can be attached to any other wearable accessory. The circuit further includes, at least two switches 301 and 302, a first switch 301 for triggering the signal and a second switch 302 for deactivating the signal, a Bluetooth/Bluetooth low energy module 303, a vibration generation means or a vibration motor 304, a plurality of resistors 305, a plurality of capacitors 306, a plurality of transistors 307, a processor including a memory 308, an amplifier 309, a supply source i.e. re-chargeable battery 310, a micro-phone 311, a plurality of color LEDs 312 and 313 and a USB port for charging in 313. In an example embodiment of the invention, the user has to press the switch 301 on the wearable accessory 300 in order to trigger or to activate an emergency assistance signal to a plurality of responders in the network. Upon triggering the switch, the wearable accessory 300 including the processor 308 activate to establish a communication between the wearable accessory 300 and the handheld device using the Bluetooth/Bluetooth low energy module 303. The communication between the wearable accessory and the handheld device may be unidirectional, bi-directional or both. Upon setting a communication between the wearable accessory and the handheld device, the wearable accessory receives an acknowledgement signal as vibration using the vibration motor 304 from the handheld device in order to provide a confirmation to the user that the emergency assistance signal has been successfully processed. The vibration motor consists of vibrations that may be long and short in order to convey different messages to the user.

The plurality of resistors 305 used to balance the flow of current in the circuit and the plurality of capacitors 306 used to store the electric charge as necessary. The plurality of transistors 307 are to amplify and switch the electric current as needed. The processor including a memory, 308, represents the SD card which can store user data, such as audio, when the emergency is triggered using the processor. The amplifier 309 to amplify the sounds received by the microphone 311 so that the audio stored and transmitted is clearly audible. The power supply or re-chargeable battery 310 powers the entire circuit of the wearable accessory. The microphone 311 which helps in collecting audio information and then the same sound gets amplified (309) and sent using Bluetooth. The accessory may include a camera (not shown in figure) for capturing the video signals or live videos. The LEDs 312 and 313 are different colored LED lights representing various signals to the users including battery health and may indicate whether an emergency has been triggered. The port 314 represents the USB charger which when plugged into a USB port can be used to re-charge the battery.

The processor coupled with the switches are capable of monitoring the activation on the first switch for a predetermined period of time to determine if the user still intends to activate an emergency. If the user does not want to activate or accidentally activated the emergency over the said predetermined period of time, the emergency signal can be deactivated using the second switch. If the user does not deactivate the emergency over the pre-determined period of time, the emergency signal gets activated.

The processor is coupled and configured with the vibration generation means for testing the power level of the stored energy supply, the logic of the processor is coupled with the stored energy supply and further coupled with the display on the wearable accessory indicating a signal representative of the power level of the stored energy supply (i.e. battery) using LED lights.

In an advantageous aspect, the present solution does not require the potential victim to reach for their phone and manually enable an application, thereby saving valuable time for distress. The responses can be felt by the potential victim in the form of vibrations instead of needing any visual confirmation. The visual confirmation by the potential victim if seen by the assailant might warn the assailant and could lead to further harm to the potential victim. The electronic circuit (enclosed in a casing), within the wearable accessory, although embedded has the flexibility of being removable and can be attached to any other wearable accessory. This makes it difficult for the perpetrator to identify, locate and possibly get rid of the wearable accessory on the victim.

Further, the present invention could relate to safety of women, children and senior citizens and extend to any individual needing emergency assistance. It could help support law enforcement agencies to act quickly to any distress signals. Overall, this could increase personal safety.

The present invention saves time; it is affordable, practical and increases safety for one ‘n’ all. It saves time, which is of the essence and is devoted to a social cause so people can act quickly in case of distress.

While the invention has been described with reference to certain embodiments, it will be understood by those skilled in the art that various changes may be made and equivalents may be substituted for elements thereof without departing from the scope of the invention. In addition, many modifications can be made to adapt a particular situation or material to the teachings of the invention without departing from the essential scope thereof. While the principles of the disclosure have been illustrated in relation to the exemplary embodiments shown herein, the principles of the disclosure are not limited thereto and include any modification, variation or permutation thereof.

The following list of claims replaces any prior listing of claims:

1. A method which enables a user to customize and notify multiple pre-configured members in the user's defined network, the method comprising:
triggering an emergency assistance signal on at least one wearable accessory;
activating at least one handheld device including a circuit upon receipt of the triggered emergency assistance signal from the wearable accessory and establishing a communication there between using a communication protocol;
recording audio and video events at the wearable accessory using a circuitry and transmitting the same to the handheld device and then to a remote server via at least one of the wearable accessory and the handheld device;
receiving an acknowledgement signal from the handheld device at the wearable accessory using the communication protocol, wherein the acknowledgement signal includes a vibration to the wearable accessory which provides confirmation that the emergency assistance signal has been triggered successfully and the same has been sent to pre-configured emergency contact stored in the handheld device;
sending alert messages with GPS/IPS location to the list of pre-configured emergency contacts at least one of social media, email, text messages, voice message, voice call etc, wherein the location of the wearable accessory by Indoor Positioning System (IPS) is based on magnetic sensor data from the handheld device which is used to wirelessly locate the user inside a building; and
updating personal information, including one or more of name, age, sex, date of birth, and blood type, on the handheld device application so the wearable accessory.

2. The method of claim 1, further comprising:
checking, by the circuit, whether the emergency assistance signal has been cancelled using wearable accessory or handheld device for a pre-determined period of time; and
upon cancelling the activation of the emergency assistance signal, one of the wearable accessory or the handheld device return backs to normal mode and provides a vibration on the wearable accessory.

3. The method of claim 1, wherein the GPS/IPS location of the wearable device is captured, converted to a location on a map, updated periodically and also sent to the pre-configured list of emergency contacts and further the alerts and user information are also stored on the secure remote server.

4. The method of claim 1, wherein the wearable accessory starts recording live audio/video through a built-in microphone and camera and starts transmitting the same to the handheld device simultaneously, and further the handheld device sends the same information received by the handheld device to the secure remote server, which then transmits it to emergency contacts, wherein the handheld device continually synchronizes with server and stores information and updates on a real-time basis.

5. A wearable accessory, including a circuitry enclosed in a casing, embedded in the wearable accessory, the circuitry comprising:
a housing;
a vibration generator for producing a vibration, the vibration generator housed within the housing;
at least one switch for allowing the wearable accessory to cause activation of the vibration generator, the switch housed within the housing;
a module for communicating with at least one handheld device using a communication protocol;
an image capturing device including a microphone for receiving at least one of audio and video signals at the wearable accessory;
a USB port for charging the wearable accessory;
a multiple-bit microprocessor configured for controlling functions of the wearable accessory, the microprocessor housed within the housing; and
a data storage for storing data representative of the signals, the data storage means coupled with the microprocessor.

6. The accessory of claim 5, wherein the vibration generator is powered by a stored energy supply, the wearable accessory further comprising a logic for testing a power level of the stored energy supply, the logic coupled with the stored energy supply and further coupled with the microprocessor for supplying the microprocessor with a signal representative of the power level of the stored energy supply using LED lights.

7. The accessory of claim 5 further comprising a deactivator coupled with the wearable accessory for deactivating the handheld device application to cancel the triggered emergency assistance signal from the wearable accessory.

8. The accessory of claim 5, wherein the circuitry of the wearable accessory provides vibrations and is configurable to provide different kinds of vibrations, wherein, the length and duration of the vibrations are configurable for different circumstances, wherein the vibration provided upon receipt of confirmation that the emergency signal has been triggered is different from a vibration provided upon receipt of a response from members in their pre-configured network.

9. The accessory of claim 7 wherein the deactivator comprises at least one switch which may be alternatively opened and closed in a preset pattern wherein the microprocessor deactivates the triggered response to the preset pattern being applied to the switch.

10. The accessory of claim 5, wherein the microprocessor is coupled with a plurality of amplifiers to amplify the sounds received by the microphone and apply a codec to optimize and compress the audio so that the audio stored and transmitted by the accessory is clearly audible.

11. The accessory of claim 5, wherein communication between the accessory and the handheld device is bidirectional.

12. The accessory of claim 5, further comprising a rechargeable battery power supply.

13. The accessory of claim 5, further comprising a transmitter and a receiver, the transmitter and receiver coupled and enclosed within the housing of the wearable accessory and configured for transmitting and receiving all audio and video signals to the remote server.

14. The accessory of claim 5, wherein the vibration generator provides vibrations at the wearable accessory in order to provide confirmation that the emergency assistance signal has been triggered successfully and the same has been sent to pre-configured list of emergency contacts of the handheld device.

15. The accessory of claim 5, wherein the triggered emergency signal is activated automatically using the handheld device which includes an application without user intervention on the application, and wherein the application on the handheld device logs usage information, including at least one of alert time, date, location and the commands received.
